(19) United States
(12) Patent Application Publication
(10) Pub. No.: US 2015/0242676 A1
(43) Pub. Date: Aug. 27, 2015

(54) Method for the Supervised Classification of Cells Included in Microscopy Images

(71) Applicant: UNIVERSITE DE NICE - SOPHIA ANTIPOLIS, Nice Cedex 2 (FR)

(72) Inventor: Michel Barlaud, Valbonne (FR)

(73) Assignee: UNIVERSITE DE NICE - SOPHIA ANTIPOLIS, Nice Cedex 2 (FR)

(21) Appl. No.: 14/371,524

(22) PCT Filed: Jan. 9, 2013
(86) PCT No.: PCT/FR2013/050048

§ 371 Date: Feb. 24, 2015

Related U.S. Application Data
(60) Provisional application No. 61/585,773, filed on Jan. 12, 2012.

(30) Foreign Application Priority Data
Jan. 12, 2012 (FR) 1250298

(51) Int. Cl. G06K 9/00; G06K 9/62; G06K 9/46

(52) U.S. Cl. CPC G06K 9/00127; G06K 9/4604; G06K 9/6267

(57) ABSTRACT

A method for supervised classification of cells contained in first and second different microscopy image formats preprocessing carried out on the basis of the first and second different image formats aiming to characterize their cell-related visual content and to transform the content into digital data; and executing a UNN algorithm-related code with the aim of processing the digital data.

### BACKGROUND

The present invention relates to a method for supervised classification of cells contained in images, possibly multimodal or multi-parametric images, for example taken with microscopes.

The expression “multimodal or multi-parametric image” is understood to mean the image resulting from the registration of various acquired images of a given sample, these images for example being obtained by various imaging techniques or by a given imaging technique with different energy levels or wavelengths, optionally simultaneously.

The expression “supervised classification” is understood to mean, in the field of machine learning, a technique in which images from an image database are automatically classed using a learning database containing examples annotated by an expert and classification rules.

In artificial intelligence, analysis of a complex system requires a classification step that aims to classify, label so to speak, each data item extracted from the system by associating it with a class.

In supervised learning, the classes are preset, the examples are known, at least certain examples are labelled beforehand, and the system learns to classify using a classification model.

By virtue of technological advances in the field of cellular imaging in recent years, it is now possible to study an increasing number of biological phenomena in increasingly greater detail.

Most of these techniques involve simultaneously analysing more than one parameter using various probes.

However, the biological effects of a given phenomenon on a population of cells may be nonuniform. For example, a change may occur with a different intensity in a number of cells or depend on the expression of certain proteins. Consequently, it becomes necessary to carry out statistical analyses on large populations of cells, populations of more than one thousand cells for example.

Prior-art techniques such as flow cytometry, in which cells are run at high speed under a laser beam in order to count them and characterize them, are very useful tools for performing such analyses.

These techniques are particularly suitable for performing powerful analyses on a large number of individual cells, but cannot be used for subcellular localization or when analysis must be performed on a group of cells, on a tissue section for example.

Moreover, high-throughput cellular imaging apparatuses are known in the prior art, these apparatuses including powerful microscopes capable of producing thousands of multimodal or multi-parametric images that may especially be used in research involving a large number of experimental conditions or samples.

However, the large number of images produced in the context of such research means that powerful devices are required in order to analyse and classify said images.

Such analysis in particular entails identifying cells in order to be able to classify them.

The prior art consists in using unsupervised classification, i.e. classification as a function of criteria relating to morphological aspect, to staining intensity or even to subcellular location.

This being the case, it will be understood that a major drawback of the prior art resides in the fact that it is difficult to precisely classify cells if they are large in number and the preset criteria are not sufficiently discriminating compared to those employed by an expert who is able to call upon multiple experience-related decision factors.

Specifically, one conventional solution is for one or more experienced human operators to carry out such cellular classification.

However, the major drawback of such a solution is that it is time-consuming but above all irreproducible.

Specifically, the number of cells to be classified is often about a few tens of thousands or even millions of cells, thus making it impossible for a human expert to count them. In addition, intraoperator and interoperator classification variability makes human evaluation irreproducible and unreliable.

### SUMMARY

The invention aims to solve the problem associated with the technical difficulties encountered in cellular identification and classification of a large number of cells.

For this purpose, one aspect of the invention relates to a method for supervised classification of cells, said cells being contained in a set of multimodal or multi-parametric images of at least one sample liable to contain nucleated cells, said multimodal or multi-parametric images resulting from the superposition of a first microscopy image format of said sample and a second microscopy image format of said sample, said multimodal or multi-parametric images being produced as or converted into digital data files and stored in a memory or a database, the method comprising the following steps:
preprocessing comprising: a step of detecting cells comprising a step consisting in identifying the location of cells or cellular regions in the first image format of a sample; forming a mask from the detected cells or cellular regions; superposing this mask on the image of the same sample in the second image format; and segmenting the image resulting from this superposition;
extracting one descriptor per detected cell, each descriptor corresponding to contrast differences in the visual content of each cell or segmented region of the cells in the segmented image; and
classifying the segmented cell into a preset class (c) by applying a classification rule to each descriptor.

According to particular embodiments usable singly or in combination:
said detection step comprises sub-steps of: verifying, consisting in validating that the cellular regions identified in the first image format are also found in the second image format; and retaining verified cellular regions the average intensity of which is sufficiently high relative to the average intensity of the entire content of the first image format;
said segmenting step consists in applying a watershed algorithm to the result of the superposition;
the extracting step comprises coding the content of each segmentation of detected cellular regions using descriptors defining the textures of this content;
the extracting step comprises the concatenation of contrast histograms;
the first and second different image formats relate to an image said to be of the nucleus and a fixation image, respectively;
the step consisting in identifying the location of the cells or cellular regions in the first image format of a sample is carried out using morphological operators;
the method furthermore comprises: a step of difference-of-Gaussian (DOG) filtering consisting in calculating a contrast coefficient (C_{Im}) for each position (x, y) in a multimodal or multi-parametric image (Im) at a scale (s) using the following relationship:

$${C}_{Im} ( x , y , s ) = {\sum }_{i} {\sum }_{i} ( Im ( i + x , j + y ) \cdot {DoG}_{s} ( i , j ) ) . ;$$

and
a step of storing said contrast coefficients in a memory; and
the classifying step comprises a step consisting in applying to the extracted descriptors a classification rule that approximates the class to which a given cell of a given image belongs using a leveraged multiclass classifier h^{l}_{c} such as:

$${h}_{c}^{𝓁} ( {x}_{q} ) = {\sum }_{j = 1}^{T} {α}_{jc} K ( {x}_{q} , {x}_{j} ) {y}_{jc}$$

According to a second aspect of the invention, a computer program comprises program code instructions for implementing the above method when the program is executed on a computer.

### BRIEF DESCRIPTION OF THE DRAWINGS

Other features and advantages of the invention will become more clearly apparent on reading the following description, given with reference to the appended figures:

FIG. 1 shows a flow chart representing the classification method according to one embodiment of the invention; and

FIG. 2 illustrates the learning step of the method according to one embodiment of the invention.

### DETAILED DESCRIPTION

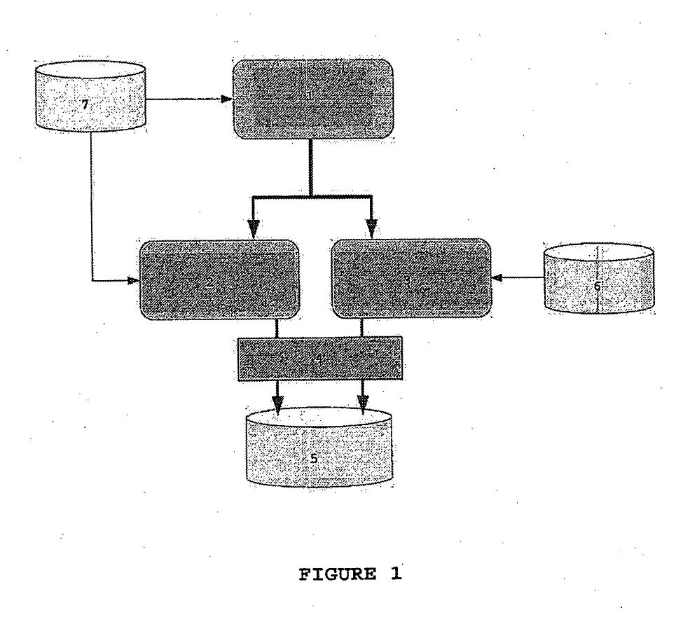

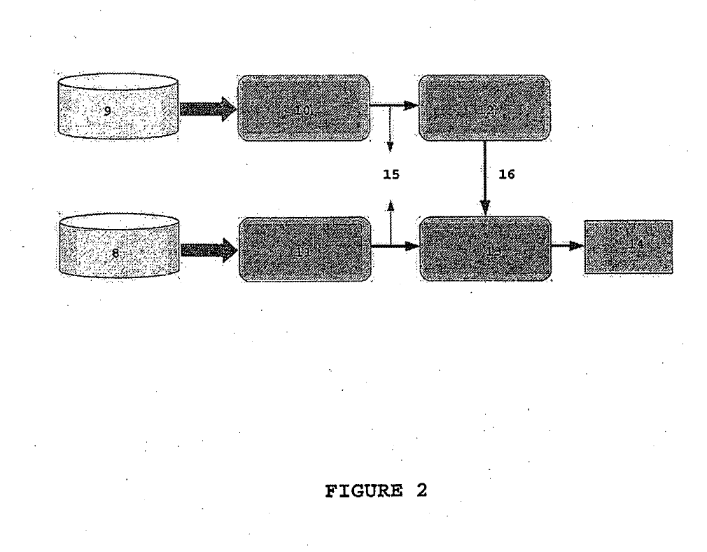

Legends of FIGS. 1 and 2
1: Detecting step;
2: Nuclear segmentation;
3: Cellular segmentation;
4: Classification;
5: Database of cells;
6: Database of fixation images;
7: Database of nuclear images;
8: Test database;
9: Learning database;
10: Bio-inspired descriptors;
11: Bio-inspired descriptors;
12: Learning;
13: Classification;
14: Validation;
15: Contrast histogram coefficients;
16: Weighted prototypes.

As explained above, it is sometimes necessary to study a population of (animal, human or plant) cells containing several thousands to hundreds of thousands of individual cells.

In this context, state-of-the-art techniques allow multimodal or multi-parametric images of the population of cells to be produced, which amounts to producing a considerable number of images to be analysed, each image possibly containing one or more nucleated cells.

Multimodal or multi-parametric images of the population of cells are for example produced by a microscope, for example in order to be processed on the fly, or stored in one or more memories.

The context of the present invention is defined by the fact that it is humanly impossible to process such volumes of data and the need for a reproducible analysing method.

As illustrated in FIG. 1, in one embodiment of the invention, the method for supervised classification of cells contained in two different image formats comprises a preprocessing step carried out on the basis of two image formats of a given sample liable to contain nucleated cells.

In one embodiment, the first image format corresponds to the image of the sample obtained with a first imaging technique, and the second image format corresponds to the image of the same sample obtained with a second imaging technique different from the first.

In another embodiment, the first image format corresponds to the image of the sample obtained with an imaging technique at a first energy level, and the second image format corresponds to the image of the same sample obtained with the same imaging technique at a second energy level.

For example, the preprocessed image is a multimodal or multi-parametric fluorescence microscopy image obtained from one and the same sample at two energy levels.

In the context of this preprocessing, the first image format relates to an image the content of which essentially comprises cell nuclei that are here made to fluoresce. Such an image is referred to as a “nuclear image”. The nuclear images are produced or converted into digital data files and stored in a database.

The second image format corresponds to an image of the same sample in the nuclear image, but the content of which relates to an overview of the cells the nuclei of which were made to fluoresce in the “nuclear image”. Such an image is here referred to as a “fixation image”. This image contains useful information with regard to classification and corresponds to an image format that for example allows the fixation of a marker such as a protein to be identified in a zone of the cell. The fixation images are produced as or converted into digital data files and stored in a database.

Preferably, the nuclear images and the fixation images are acquired with the same geometry and the same image size. If this is not the case, a step of processing one of the two images is provided so that the second image format can be directly superposed on the first image format.

The preprocessing step aims to characterize visual content relating to the cells present in these two image formats, this content being converted into digital data.

To do this, this preprocessing step comprises a step of detecting cells (which may be deformed between microscope slides) in the first image format, i.e. in the nuclear image.

This step of detecting cells comprises a step consisting in identifying the location of cells or cellular regions in the nuclear image, and then in verifying that these locations are trustworthy.

For this purpose, provision is made to localize in the nuclear image the regions of its content that are liable to relate to cells, for example via a particular process implementing morphological operators, applied to the nuclear image. Provision may be made to first convert the nuclear image into a binary image via automatic thresholding. This binary image is then processed using conventional morphological operators.

The detected cells or cellular regions form a logical mask of cellular regions making a filtering step possible, in this case only of cells. Provision is then made for a superposing step consisting in superposing the mask on a previously defined image gradient of the corresponding fixation image, i.e. the mask obtained from the nuclear image of a sample is superposed on the fixation image of the same sample, where the expression “image gradient” is understood to mean the first derivative operator applied to the intensity values of the image. As is known, the image gradient may be obtained by taking the first derivative of the pixels in the image in question.

Provision is then made for a segmenting step in which a watershed algorithm is applied to the image resulting from the superposition, so as to obtain a segmented image.

Once the segmentation has been performed, a step of extracting descriptors of the cells from the segmented image is then carried out. This extracting step aims to code the visual content of each cell or segmented region using descriptors representing the cells in the segmented image, as described below.

The term “descriptors” is understood to mean descriptors as used in the context of supervised learning, i.e. allowing a representation change.

To determine whether a segmented image belongs to a preset class, it is approximated that a function or an algorithm (described below) exists that, applied to the descriptors of a given segmented image, allows the class belonged to to be deduced therefrom. The choice of descriptors is therefore important.

In the current instance, the descriptors define contrast differences in the visual content of each cell or segmented region. The expression “contrast difference” is understood to mean, as is known, the second derivative of the values of the intensity of the segmented image. Provision may be made to take the second derivative with respect to space (i.e. with respect to the pixels of the image), to time or to both time and space. The descriptors provide a compact representation of the localized contrast difference inside a cellular region and also that at the boundary of a cell: to one cell corresponds one descriptor. A segmented image comprising N cells or cellular regions is coded in the extracting step using N descriptors: to one descriptor corresponds one cell and vice versa. The advantage of the present solution is that a contrast is positive, whereas prior-art gradients are signed (positive or negative). Furthermore, such contrast-based representation mimics the function of the retina.

Thus, to define the descriptor of a cell or given cellular region in a given segmented image, provision is made for a dividing step that consists in dividing said cell or given cellular region into subregions, in the current instance corresponding: to the membrane, to the cytoplasm and to the nucleus of the cell. This dividing step is typically carried out using known morphological operators.

It will be noted that a cell contains a nucleus, cytoplasm and a membrane. However, as the membrane is of negligible size it is associated with the cytoplasm. There are therefore three entities but only two regions are considered, one of the regions including the membrane and cytoplasm.

Next, provision is made for a step of filtering said subregions. In the current instance, difference-of-Gaussian (DOG) filtering is applied to these subregions at a number of different scales, so as to generate details of contrast differences at various spatial resolutions. This generation of contrast details at various spatial resolutions allows a representation of contrast to be obtained such as is liable to be seen by the human eye. For example, provision is made to use four different scales.

For this purpose, a step is provided that consists in defining local contrast coefficients for each subregion.

The contrast coefficient C_{Im} for each position (x, y) in an image Im at a scale s is given by the following relationship:

The values calculated for the contrast coefficients are stored in a memory.

Next, a bounded transfer function R referred to as a firing rate function is applied to each contrast coefficient value C_{Im}, this function being such that R(C_{Im})=G*C_{Im}/(I+Ref*G*C_{Im}) where G is the contrast gain, preferably equal to 2000 Hz/contrast, and Ref is the refractory period approximating the time interval during which a neuron cell reacts, Ref preferably being equal to 0.005 seconds.

The calculated firing rate values R(C_{Im}) are stored in a memory.

For each subregion, the calculated firing rate values R(C_{Im}) are quantified into normalized histograms then concatenated.

The step of calculating the descriptor of each cell is thus carried out by concatenating contrast histograms over the calculated subregions at the scales in question, thus creating a single resultant visual descriptor that is specific to one cell.

This type of descriptor has the advantage of consuming far less of the computational resources of the system liable to implement it than those consumed by prior-art mechanisms using histograms of gradient directions over blocks of pixels, as these blocks of pixels are much smaller than the regions and have no physical meaning with respect to the cells.

Consequently, the histograms are calculated directly over the segmented cellular regions and these histograms form the descriptors of these cells.

This calculating step allows, for a cell or a given cellular region of a given segmented image, a subcellular region-based bio-inspired descriptor to be obtained, i.e. the calculation of the contrast coefficients and their concatenation into histograms gives biologically inspired results that are similar to human vision, at the level of cellular subregions, for example the membrane, nucleus and cytoplasm.

Therefore, the descriptors according to the invention represent the cells in a way similar to the way in which they are seen by the human eye.

Each image is thus associated with one or more descriptors, a single descriptor if the image contains only one cell and as many descriptors as the image contains cells if the image contains more than one cell.

In order to classify the images, or more exactly classify the cells contained in the images, it is then necessary to implement a processing step consisting in applying, to these descriptors, a classification rule, i.e. a function or an algorithm that approximates the class to which a given cell of a given image belongs.

Thus, an image containing N cells may be classed (at most) into N classes.

To classify a given cell contained in a given image, in the processing step a computer, i.e. a piece of electronic equipment for automatically processing data, capable of implementing the method, executes, using its processing means—microprocessor and memory storage means—a program code coding said classification rule, which is applied to the descriptors of the given cell.

An image can be classified on the basis of the histograms that represent an image. This is done in the following way: the distance between the histograms is calculated and this calculation is used to say which cell is the closest. For example, if xi, yi are two images, i varying from 1 to m (number of components), whatever xi and yi the following formula is applied to calculate the distance between these two images: (sigma (xi−yi)²)/m.

Selection takes place on a shortest distance basis.

The symbol c defines a class among a set of C preset classes; i.e. c=1, 2, . . . , C.

For each cell, a positive or negative degree of membership (or score) is defined for each of the classes c. The class with the highest degree of membership is then selected and the cell is considered to belong to the class c selected.

Next provision is made to count the number of cells in each of the classes, thereby for example allowing a comparison to be made between the number of cells in at least two classes. Likewise, provision may be made to reiterate the method over time, thereby allowing the number of cells in a given class at a given time t to be compared to the number of cells in the same given class at another time t+dt. In this way, the variation over time in the number of cells in a preset class may be followed.

The classification rule is coded in the computer program by way of the following algorithm, which is a generalization of the K nearest neighbour (k-NN) method to the following leveraged multiclass classifier h_{c}^{l}:

$${h}_{c}^{𝓁} ( {x}_{q} ) = {\sum }_{j = 1}^{T} {α}_{jc} K ( {x}_{q} , {x}_{j} ) {y}_{jc}$$

where:

α_{jc}: leveraging coefficients that are dependent on the class c, these coefficients corresponding to the linear classification coefficients of the prototypes and providing a weighted voting rule instead of uniform voting;

x_{q}: a coefficient that denotes the query, i.e. a membership query of a cell in a given image to a given class c;

xⱼ: a coefficient that denotes the descriptor of the prototype;

y_{jc}: is the label, set by an expert, of the (positive/negative) prototype belonging to the class c;

T: corresponds to the size of the set of prototypes that are authorized to vote; and

K(. , .): is a weight associated with the rank of the j^{th} k-NN for the query x_{q}.

NNₖ(xᵢ) denotes the k nearest neighbours of the prototype xᵢ. h_{c}^{l} is the membership score of the image Xq for the class c.

Therefore here, the descriptor is Xq, h the classifier and c the class. For the class c, the highest score h_{c}^{l} is elected.

The result obtained by applying the classification rule h^{l}_{c(}x_{q)} then allows the cell to be classed (the class retained is that which obtains the best score), then stored in a cell database.

The method described is a supervised classification method that therefore requires a learning step in the context of its application.

With reference to FIG. 2, this learning step allows the accuracy of the classification to be improved by calculating prototypes for a supervised classifier resulting from cells annotated by an expert by minimizing a misclassification function, i.e. bad classification.

The prototypes are defined in the (prior) learning step in which each prototype is a subset of known examples, i.e. of images or cells annotated by an expert as belonging to at least one class c, for which the cardinality is smaller than a threshold value, for example the number of annotated images in the learning database.

To do this, cellular images annotated by an expert biologist and stored in a learning database allow the parameters of the supervised classification method to be calculated and compared to those resulting from the processing of cellular images archived in the test database, and thus the classification to be validated in terms of accuracy in a validation step.

This learning step comprises a substep of forming classifiers, consisting essentially in selecting the most accurate data subsets from the learning database, i.e. prototypes the cardinal T of which is generally smaller than the number m of annotated instances.

These weighted prototypes are selected by first fitting the coefficients αⱼ, then by removing the examples with the smallest coefficients αⱼ, which are considered as being too inaccurate to be considered as prototypes.

The process is iterative.

With a view to fitting the classification rule h^{l}_{c(}x_{q)} to the selected data subset, the exponential surrogate risks are minimized as follows:

$${ɛ}^{exp} ( {h}_{c}^{𝓁} , S ) = \frac{1}{m} {\sum }_{i = 1}^{m} exp \{ - ρ ( {h}_{c}^{𝓁} , i ) \}$$

where:

ρ(h_{c}^{l},i)=y_{ic}h_{c}^{l}(xᵢ)

where:

ε^{exp}(h_{c}^{l},S) is the risk function; and
ρ(h_{c}^{l},i)=y_{ic}h_{c}^{l}(xᵢ) is the misclassification function, xᵢ corresponding to one example.

It is thus possible to measure the quality of the fit of the classification rule using the prototype (xᵢ;yᵢ) for the class c, the result being positive if the prediction agrees with the annotated example.

The UNN algorithm solves this optimization problem using an iterative mechanism in which the classification rule is updated by adding thereto a new prototype (xᵢ;yⱼ) (weak classifier) in each step t (t=1, 2, . . . , T), the leveraging coefficient αⱼ of which is calculated with the literal expression:

$${α}_{j} = 0.5 Log \frac{{w}_{j}^{+}}{{w}_{j}^{-}}$$

where:

wⱼ⁺ and wⱼ⁻ are the sums of the j^{th} good and bad reverse k-NN weights, updated in each iteration.

It will be noted that for alternative methods such as the SVM (support vector machine) method, calculation of the coefficients requires a system of equations to be solved.

It will clearly be understood that the linear classification cost with respect to the number of examples is less than the quadratic cost of prior-art classification methods.

Thus, it will be readily understood that such a solution makes automatic supervised classification possible.

For convenience of language, the expressions “supervised classification of cells” and “supervised classification of images (of cells)” have been used interchangeably.

By virtue of the invention, on the basis of 500 cells annotated by an expert, the accuracy of the proposed method may be higher than 84%, which is better than intra-expert and inter-expert variability. The execution time for the classification and counting is 5 s for 5000 images on a conventional workstation. Thus, automatic classification of millions of cells may be envisioned.

1.-10. (canceled)

11. A method for supervised classification of cell where the cells are contained in a set of multimodal or multi-parametric images of at least one sample liable to contain nucleated cells and the multimodal or multi-parametric images result from the superposition of a first microscopy image format of the sample and a second microscopy image format of the sample, with the multimodal or multi-parametric images being produced as or converted into digital data files and stored in a memory or a database; the method comprising:
detecting cells by identifying the location of cells or cellular regions in the first image format of a sample; forming a mask from the detected cells or cellular regions; superposing the mask on the image of the same sample in the second image format; and segmenting the image resulting from this superposition;
extracting one descriptor per detected cell, each descriptor corresponding to contrast differences in a visual content of each cell or segmented region of the cells in the segmented image; and
classifying the segmented cell into a preset class by applying a classification rule to each descriptor.

12. The method according to claim 11, wherein the detection step comprises:
verifying by validating that the cellular regions identified in the first image format are also found in the second image format; and
retaining verified cellular regions, an average intensity of which is sufficiently high relative to an average intensity of an entire content of the first image format.

13. The method according to claim 11, wherein the segmenting includes applying a watershed algorithm to a result of the superposition.

14. The method according to claim 11, wherein the extracting comprises coding the content of each segmentation of detected cellular regions using descriptors defining textures of this content.

15. The method according to claim 14, wherein the extracting step comprises the concatenation of contrast histograms.

16. The method according to claim 11, wherein the first and second different image formats relate to an image said to be of a nucleus and a fixation image, respectively.

17. The method according to claim 11, wherein the identifying the location of the cells or cellular regions in the first image format of a sample is carried out using morphological operators.

18. The method according to claim 11 further comprising:
filtering a difference-of-Gaussian (DOG) by calculating a contrast coefficient (Cₗₘ) for each position (x, y) in a multimodal or multi-parametric image (Im) at a scale (s) using the following relationship:
$${C}_{Im} ( x , y , s ) = {\sum }_{i} {\sum }_{i} ( Im ( i + x , j + y ) \cdot {DoG}_{s} ( i , j ) ) . ;$$
and
storing the contrast coefficients in a memory.

19. The method according to claim 11, wherein the classifying comprises applying to the extracted descriptors a classification rule that approximates the class to which a given cell of a given image belongs using a leveraged multiclass classifier h^{l}_{c} comprising
$${h}_{c}^{𝓁} ( {x}_{q} ) = {\sum }_{j = 1}^{T} {α}_{jc} K ( {x}_{q} , {x}_{j} ) {y}_{jc}$$

20. A computer program comprising program code instructions for implementing the method according to claim 11 when the program is executed on a computer.
